(19) United States
(12) Patent Application Publication
(10) Pub. No.: US 2010/0163661 A1
(43) Pub. Date: Jul. 1, 2010

(54) Paper Shredder with a Suction Apparatus for Vacuum Cleaner

(76) Inventor: Tie-Jiun Wang, Taipei (TW)

Correspondence Address: FRENKEL & ASSOCIATES, 3975 UNIVERSITY DR., STE. 330, FAIRFAX, VA, 22030, US

(21) Appl. No.: 12/344,758

(22) Filed: Dec. 29, 2008

(51) Int. Cl. B02C 1/08

(52) U.S. Cl. 241/224

(57) ABSTRACT

The present invention relates generally to a paper shredder, and more particularly to a paper shredder with a suction apparatus for vacuum cleaner comprising:

a paper shredder unit with a receiving compartment fitted within its interior and a suction connecting port fitted to the lower part of paper shredder unit that can be connected through to the receiving compartment,

a vacuum cleaner unit with a filling compartment fitted within its interior;

a vacuum connector with one end to be inserted and coupled to the corresponding suction connecting port and the other end to be connected to the vacuum cleaner unit through a flexible pipe so that the shredded papers inside the receiving compartment can be vacuumed out by the air suction force generated from the vacuum cleaner unit. It is very convenient and without any labor force that the clearance of shredded papers from the interior of paper shredder unit can be effortlessly performed; therefore, the mass production of the present invention is very suitable for the industry.

### BACKGROUND OF THE INVENTION

1. Field of the Invention

The present invention relates generally to a paper shredder, and more particularly to a paper shredder with a suction apparatus for vacuum cleaner.

2. Description of the Prior Art

Referring the FIG. 1 for the prior art, a conventional paper-shredder currently sold in the market is shown that consists of a paper shredding unit 10; wherein, a shredded paper collection chest 101 that has a receiving compartment 100 in its interior for collecting the waste papers is mounted inside the paper shredder unit 10 while a slot-inlaid handle 102 is fitted onto the shredded paper collection chest 101; when generally using the unit is desired, just load the waste papers into the paper shredder from its inlet 103 to activate the paper shredding unit 10 to perform the paper-shredding action; thus a performance of fully cutting the waste papers is achievable.

Nevertheless, the foregoing prior art has the following imperfections: the paper shredder unit 10 cannot be used any longer once shredded the waste paper to a certain volume due to a limited interior space of receiving compartment 100; by then, the user cannot but use both his hands to grab the slot-inlaid handle 102 tightly to hold and take out the shredded paper collection chest 101 fully, and then pour out to empty the shredded papers from the shredded paper collection chest 101 and plug it back into the paper shredder unit 10 in place; it is such a significant drawback that consumes too much labor force against the desire for everything to be simple, light and convenient in the current era while this drawback weakens the consumer's desire to purchase the unit.

In the light of the aforementioned imperfections from the prior art, the present invention proposes a paper shredder with a suction apparatus for vacuum cleaner to solve the drawbacks existing in the prior art.

### SUMMARY OF THE INVENTION

The primary objective of the present invention is to provide a paper shredder with a suction apparatus for vacuum cleaner, wherein, a vacuum connector on the vacuum cleaner unit can be plugged to the suction connecting port pre-fitted to the paper shredding unit so that the suction force from the vacuum cleaner can be taken to suck out the shredded papers inside the paper shredder unit automatically; manually clearing the shredded papers from the paper shredder unit; manual clearance of shredded papers from the paper shredder unit is not necessary while the convenience of using the unit is achievable.

Another objective of the present invention is to provide a paper shredder with a suction apparatus for vacuum cleaner, wherein, the vacuum cleaner unit can be replaced with a machine unit that generates suction aerodynamic force to achieve the objective of vacuuming out the shredded papers from the interior of paper shredder unit.

The foregoing objectives of the present invention are attained by a paper shredder, and more particularly by a paper shredder with a suction apparatus for vacuum cleaner that comprises of a paper shredder unit with a receiving compartment fitted within its interior and a suction connecting port fitted to the lower part of paper shredder unit as the connecting apparatus that can be connected through to the receiving compartment, a vacuum cleaner unit with a filling compartment fitted within its interior; a vacuum connector with one end to be inserted and coupled to the corresponding suction connecting port and the other end to be connected to the vacuum cleaner unit through a flexible pipe so that the shredded papers inside the receiving compartment can be vacuumed out by the air suction force generated from the vacuum cleaner unit; it is very convenient and without any labor force that the clearance of shredded papers from the interior of paper shredder unit can be effortlessly performed; therefore, the mass production of the present invention is very suitable for the industry.

The detailed descriptions of preferred embodiments set forth below in conjunction with the accompanying drawings wherein are provided for a complete and better understanding of the present invention with respect to thereof objectives, technical descriptions, features and achieved performance.

### BRIEF DESCRIPTOIN OF THE FIGURES

FIG. 1 is a schematic view of the prior art.

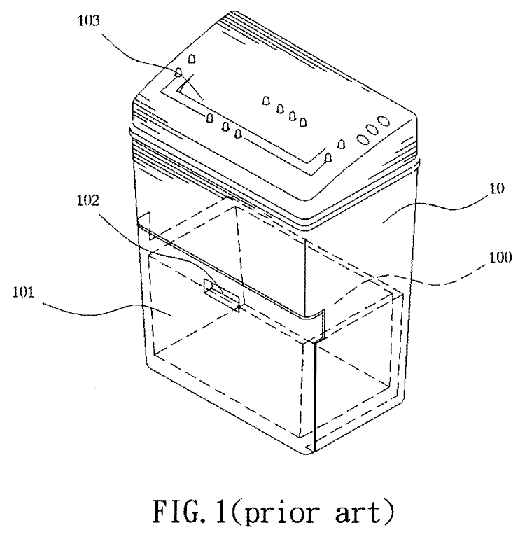

FIG. 2 is a schematic view in three-dimension of the present invention with a thin paper shredder unit connected to a vacuum cleaner unit.

FIG. 3 is a schematic and enlarged view for the suction connecting port and the structure of vacuum connector in the present invention.

### REPRESENTATIVE FIGURES DESIGNATED TO THE PRESENT INVENTION

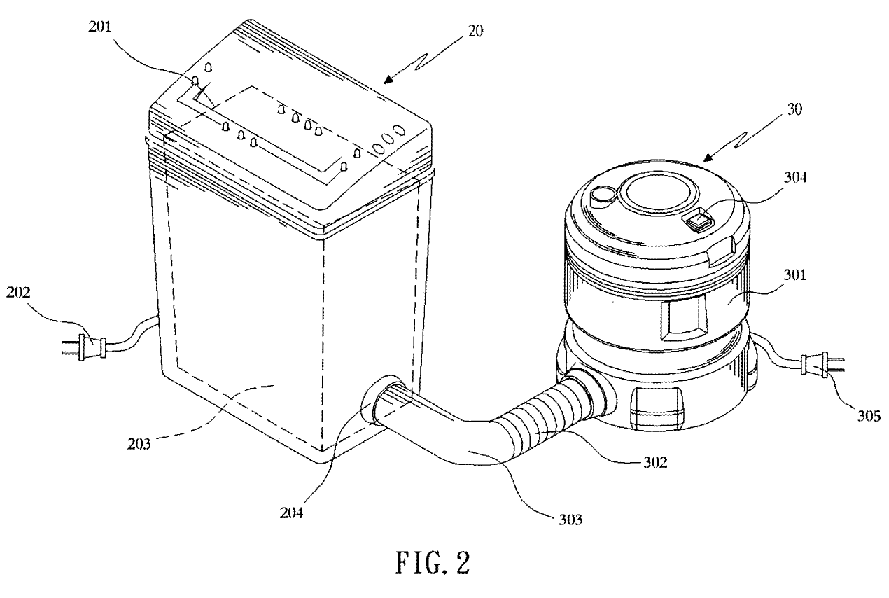

(I) The representative figure designated to the present invention is: the FIG. 2.

(II) Elements and thereof reference numbers used in the representative figure are as follows:

Paper shredder unit 20

Waste papers inlet 201

Plug 202

Receiving compartment 203

Suction connecting port 204

Vacuum cleaner unit 30

Filling compartment 301

Flexible pipe 302

Vacuum connector 303

Control switch 304

Plug 305

### DESCRIPTION OF REFERENCE NUMBERS FOR MAJOR ELEMENTS

(For the prior art)

Paper shredder unit 10

Receiving compartment 100

Shredded papers collection chest 101

Slot-inlaid handle 102

Inlet 103

(For the present invention)

Paper shredder unit 20

Waste paper inlet 201

Plug 202

Receiving compartment 203

Suction connecting port 204

Vacuum cleaner unit 30

Filling compartment 301

Flexible pipe 302

Vacuum connector 303

Plug 305

### DETAILED DESCRIPTION OF THE PREFERRED EMBODIMENTS

A detailed description of the preferred embodiments in conjunction with the accompanying figures is provided below for the Examiner to conveniently and concisely understand other featured contents and advantages together with the obviousness of thereof achieved performance:

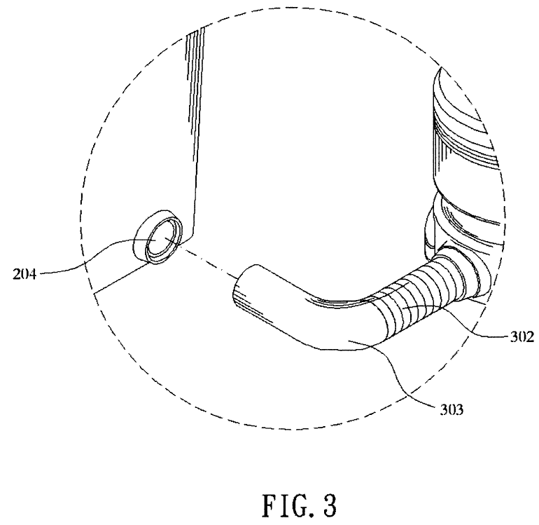

Referring to the FIG. 2 for a schematic view in three-dimension of the present invention with a thin paper shredder unit connected to a vacuum cleaner unit and the FIG. 3 for a schematic and enlarged view for the suction connecting port and the structure of vacuum connector in the present invention, the present invention as shown in the figures comprises of a paper shredder unit 20 with a waste paper inlet 201 fitted where the waste papers are loaded for shredding action and a plug 202 provided that can be plugged into the power supply outlet from the city electricity to supply power to the paper shredder unit 20; a receiving compartment 203 is mounted within the interior of the paper shredder unit 20 and a suction connecting port 204 fitted at the base of the paper shredder unit 20 that can be connected through to the receiving compartment 203 while this suction connecting port 204 is structured as a check valve;

A vacuum cleaner unit 30 with a filling compartment 301 fitted within its interior that can vacuum the external trash into the interior of filling compartment 310 through a flexible pipe 302 for connection; wherein, one end of the flexible pipe 302 is connected to the vacuum cleaner unit 30 while the other end of the flexible pipe is connected to a vacuum connector 303 as the counterpart corresponding to the suction connecting port 204 that can be inserted and coupled to the suction connecting port 204 to vacuum out the shredded papers inside the receiving compartment 203 from the interior of paper shredder unit 20 to the interior of vacuum cleaner unit 30; meanwhile, a control switch 304 and a plug 305 that can be plugged into outlet of power supply from city electricity are mounted in the vacuum cleaner unit 30 to further control the on and off of the vacuum cleaner unit 30; also, the vacuum cleaner unit 30 can be replaced with a machine unit that can generate an aerodynamic suction force.

The primary objective of the present invention is to plug the vacuum connector 303 from the vacuum cleaner unit 30 into the suction connecting port 204 pre-fitted in the paper shredder unit 20 so that the shredded papers within the interior of the paper shredder unit 20 can be vacuumed out automatically by the suction force generated from the vacuum cleaner unit 30; manual clearance of shredded papers from the interior of paper shredder unit 20 is unnecessary any longer while the objective of conveniently using the present invention is achievable.

Also, the vacuum connector 303 and the flexible pipe 302 to be used in vacuum cleaner unit 30 are not limited to be a general connector and flexible pipe; they can be replaced with any paper-suction apparatus that applies the principle of vacuum to suck and carry the shredded papers to a separate container through different carrying methods before the receiving compartment 203 receives too much shredded papers; thus the complicated steps of manual operation can be skipped.

It is concluded from the foregoing preferred embodiments that the present invention has achieved thereof desired performance for improvement to break through the structure in the prior art while the present invention is not easy to be had in mind by those people who are familiar with the said workmanship; furthermore, the present invention has not been disclosed prior to its application for patent while thereof possessed novelty and utility are compliant with the requisites of application for an invention of patent; hence an application for patent is filed in accordance with the statutes of patent while an approval from your esteem Bureau to this application for the present invention, as an encouragement to the invention, will be highly appreciated.

The foregoing preferred embodiments are simply to describe the technical ideas and features of the present invention while thereof objectives are to allow those people who know the said workmanship very well can understand the contents of the present invention and put them into practice accordingly; therefore, it is intended that the descriptions of the preferred embodiments for the present invention illustrate rather than limit the present invention; that is, all the simply equivalent changes and modifications made to the spirits disclosed in the present invention shall be resided within the scope of patent set forth below for the present invention.

What is claimed is:

1. A paper shredder with a suction apparatus for vacuum cleaner that comprises at least:
a paper shredder unit with a receiving compartment fitted within its interior and a suction connecting port fitted to the lower part of paper shredder unit that can be connected through to the receiving compartment, and
a vacuum cleaner unit with a filling compartment fitted within its interior; a vacuum connector with one end to be inserted and coupled to the corresponding suction connecting port and the other end to be connected to the vacuum cleaner unit through a flexible pipe so that the shredded papers inside the receiving compartment can be vacuumed out and carried to the interior of filling compartment by the air suction force generated from the vacuum cleaner unit.

2. A paper shredder with a suction apparatus for vacuum cleaner as claimed in the claim 1, wherein, the suction connecting port is structured as a check valve.

3. A paper shredder with a suction apparatus for vacuum cleaner as claimed in the claim 1, wherein, the vacuum cleaner unit is further included a plug that can be connected to the city electricity as power supply to the vacuum cleaner unit.

4. A paper shredder with a suction apparatus for vacuum cleaner as claimed in the claim 1, wherein, the paper shredder unit is further included a plug that can be connected to the city electricity as power supply to the paper shredder unit.

5. A paper shredder with a suction apparatus for vacuum cleaner as claimed in the claim 1, wherein, the vacuum cleaner unit is further included a control switch.

6. A paper shredder with a suction apparatus for vacuum cleaner as claimed in the claim 1, wherein, the vacuum cleaner unit can be replaced with a machine unit that generates an aerodynamic suction force.
